(19) United States
(12) Patent Application Publication
(10) Pub. No.: US 2015/0212861 A1
(43) Pub. Date: Jul. 30, 2015

(54) VALUE SYNCHRONIZATION ACROSS NEURAL PROCESSORS

(71) Applicant: QUALCOMM Incorporated, San Diego, CA (US)

(72) Inventors: Michael-David Nakayoshi CANOY, San Diego, CA (US); Yinyin LIU, San Diego, CA (US); Victor Hokkiu CHAN, San Diego, CA (US); Michael CAMPOS, La Jolla, CA (US); Jeffrey Alexander LEVIN, San Diego, CA (US); Casimir Matthew WIERZYNSKI, San Diego, CA (US)

(73) Assignee: QUALCOMM Incorporated, San Diego, CA (US)

(21) Appl. No.: 14/163,893

(22) Filed: Jan. 24, 2014

(51) Int. Cl. G06F 9/52; G06N 3/08

(52) U.S. Cl. CPC G06F 9/52; G06N 3/08

(57) ABSTRACT

Values are synchronized across processing blocks in a neural network by encoding spikes in a first processing block with a value to be shared across the neural network. The spikes may be transmitted to a second processing block in the neural network via an interblock interface. The received spikes are decoded in the second processing block so as to generate a value that is synchronized with the value of the first processing block.

### BACKGROUND

1. Field

Aspects of the present disclosure generally relate to neural system engineering and, more particularly, to systems and methods for synchronizing values across neural processors of a neural network.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

Execution of large neural models may span multiple neural processors. The information shared between neural processors may be limited to neural spikes. Still, the model may specify for the use of non-spikes values (i.e. neuromodulators) and for those values to be synchronized across neural processors for proper execution. Thus, it is desirable to provide a neuromorphic mechanism to synchronize values across neural processors of a neural network.

### SUMMARY

In an aspect of the present disclosure, a method for synchronizing values across processing blocks is disclosed. The method includes generating spikes corresponding to a first value in a first processing block. The method further includes transmitting the spikes across an inter-block interface from the first processing block to a second processing block. The spikes are encoded with the first value such that a second value generated in the second processing block based on the spikes will be synchronized with the first value.

In another aspect of the present disclosure, a method for synchronizing values across processing blocks is disclosed. The method includes receiving spikes corresponding to a first value from a first processing block and decoding the spikes in a second processing block to generate a second value. The second value is synchronized with the first value.

In yet another aspect of the present disclosure, a first processing block for synchronizing values with a second processing block is disclosed. The first processing block includes a value generator(s). The first processing block also includes value neurons configured to generate spikes corresponding to a first value, and to transmit the spikes to the value generator(s) and also across an inter-block interface to proxy neurons within a second processing block. The spikes are encoded with the first value such that a second value generated in the second processing block based on the spikes will be synchronized with the first value. The first processing block further includes a neuron(s) configured to receive the first value from the value generator(s).

In still another aspect of the present disclosure, an apparatus for synchronizing values across processing blocks is disclosed. The apparatus includes a memory and a processor(s) coupled to the memory. The processor(s) is configured to generate spikes corresponding to a first value in a first processing block. The processor(s) is also configured to transmit the spikes across an inter-block interface from the first processing block to a second processing block. The spikes are encoded with the first value such that a second value generated in the second processing block based on the spikes will be synchronized with the first value.

In a further aspect of the present disclosure, an apparatus for synchronizing values across processing blocks is disclosed. The apparatus includes a memory and a processor(s) coupled to the memory. The processor(s) is configured to receive spikes corresponding to a first value from a first processing block. The processor(s) is further configured to decode the spikes in a second processing block to generate a second value that is synchronized with the first value.

In yet another aspect of the present disclosure, an apparatus for synchronizing values across processing blocks is disclosed. The apparatus includes means for generating spikes corresponding to a first value in a first processing block. The apparatus also includes means for transmitting the spikes across an inter-block interface from the first processing block to a second processing block. The spikes are encoded with the first value such that a second value generated in the second processing block based on the spikes will be synchronized with the first value.

In yet another aspect of the present disclosure, an apparatus for synchronizing values across processing blocks is disclosed. The apparatus includes means for receiving spikes corresponding to a first value from a first processing block. The apparatus also includes means for decoding the spikes in a second processing block to generate a second value, the second value being synchronized with the first value.

In still another aspect of the present disclosure, a computer program product for synchronizing values across processing blocks is disclosed. The computer program product includes a non-transitory computer readable medium having program code recorded thereon. The program code includes program code to generate spikes corresponding to a first value in a first processing block. The program code further includes program code to transmit the spikes across an inter-block interface from the first processing block to a second processing block. The spikes are encoded with the first value such that a second value generated in the second processing block based on the spikes will be synchronized with the first value.

In a further aspect of the present disclosure, a computer program product for synchronizing values across processing blocks is disclosed. The computer program product includes a non-transitory computer readable medium having program code recorded thereon. The program code includes program code to receive spikes corresponding to a first value from a first processing block. The program code further includes program code to decode the spikes in a second processing block to generate a second value. The second value is synchronized with the first value.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of a spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 is a high level block diagram illustrating an exemplary system architecture for synchronizing values between neural processors in a neural network in accordance with aspects of the present disclosure.

FIG. 6 is a high level block diagram illustrating an exemplary system architecture for synchronizing values between neural processors in a neural network in accordance with aspects of the present disclosure.

FIG. 7 is a high level block diagram illustrating an exemplary system for encoding and decoding spikes in accordance with aspects of the present disclosure.

FIG. 8 illustrates an example implementation of a method for synchronizing values across processing blocks in a neural network using a general-purpose processor in accordance with certain aspects of the present disclosure.

FIG. 9 illustrates an example implementation for synchronizing values across processing blocks of the neural network in accordance with certain aspects of the present disclosure.

FIG. 10 illustrates an example implementation of the aforementioned method for synchronizing values across processing blocks of a neural network in accordance with certain aspects of the present disclosure.

FIG. 11 illustrates a method for synchronizing values across processing blocks of a neural network in accordance with certain aspects of the present disclosure.

FIG. 12 illustrates a method for synchronizing values across processing blocks of a neural network in accordance with certain aspects of the present disclosure.

FIG. 13 illustrates an example implementation of a neural network in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

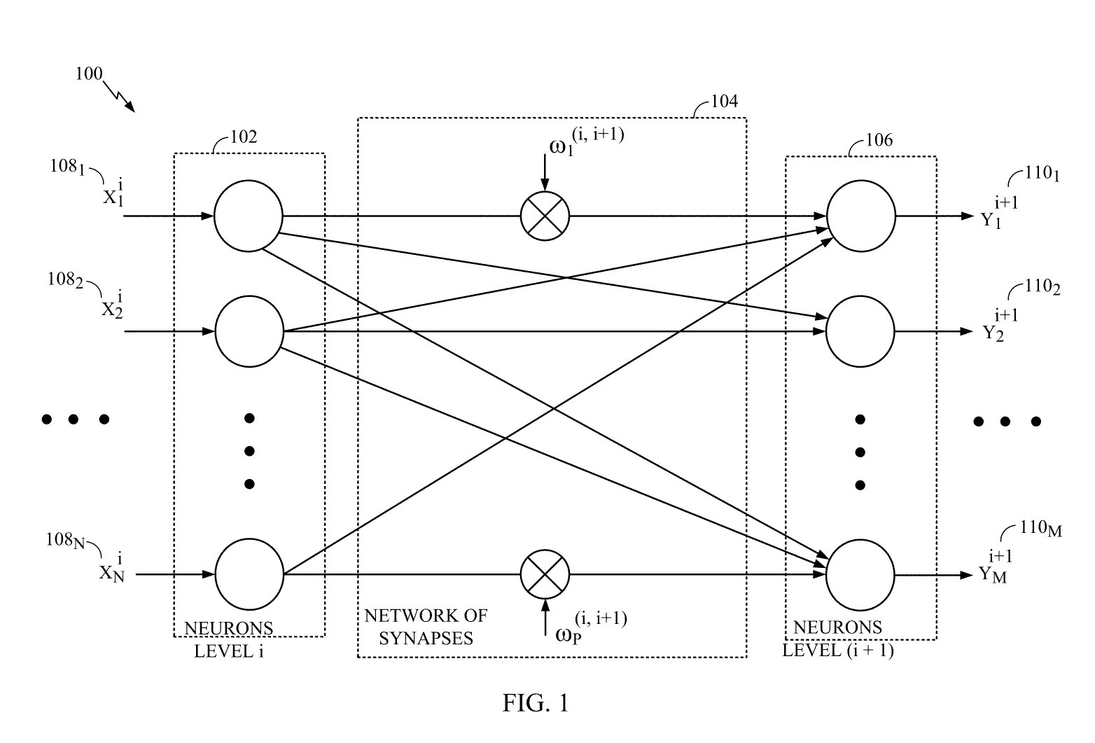

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered pre-synaptic neurons and neurons of level 106 may be considered post-synaptic neurons. The synapses 104 may receive output signals (i.e., spikes) from the level 102 neurons and scale those signals according to adjustable synaptic weights w₁^{(i,i+1)}, . . . , w_{P}^{(i,i+l)} where P is a total number of synaptic connections between the neurons of levels 102 and 106 and is an indicator of the neuron level. For example, in the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

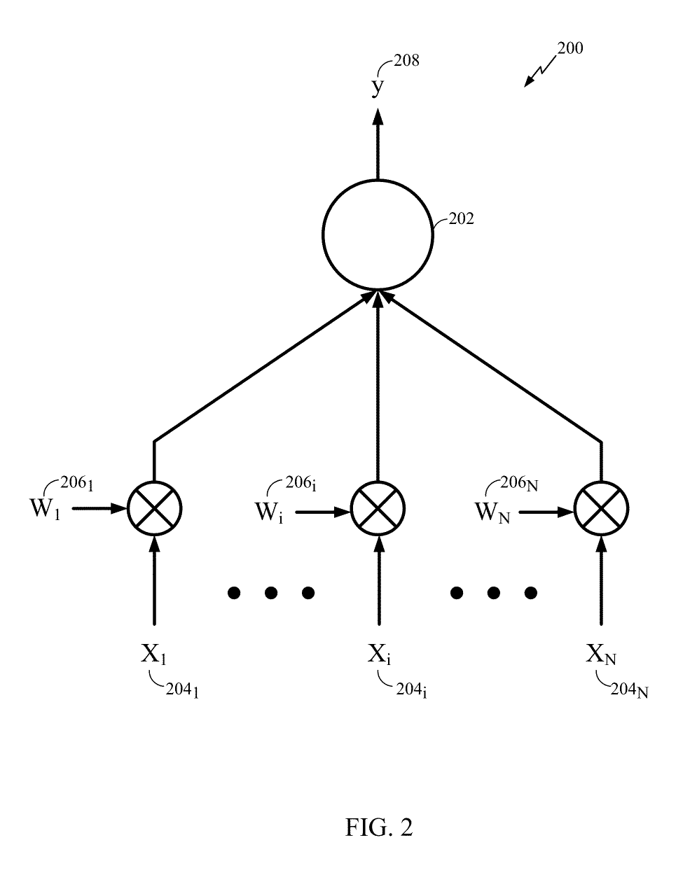

FIG. 2 illustrates an example 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N} (X₁-X_{N}), which may be signals external to the neural system, or signals generated by other neurons of the same neural system, or both. The input signal may be a current, a conductance, or a voltage, real-valued or complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁₋M_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, or a voltage, real-valued or complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, processing of synapse related functions can be based on synaptic type. Synapse types may comprise non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of this is that processing can be subdivided. For example, non-plastic synapses may not require plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) since structural plasticity (i.e., an amount of delay change) may be a direct function of pre-post spike time difference. Alternatively, it may be set as a function of the weight change amount or based on conditions relating to bounds of the weights or weight changes. For example, a synapse delay may change only when a weight change occurs or if weights reach zero but not if they are maxed out. However, it can be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity”. Consequently, inputs that might be the cause of the post-synaptic neuron's excitation are made even more likely to contribute in the future, whereas inputs that are not the cause of the post-synaptic spike are made less likely to contribute in the future. The process continues until a subset of the initial set of connections remains, while the influence of all others is reduced to an insignificant level.

Since a neuron generally produces an output spike when many of its inputs occur within a brief period, i.e., being cumulative sufficient to cause the output, the subset of inputs that typically remains includes those that tended to be correlated in time. In addition, since the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a pre-synaptic neuron to a post-synaptic neuron as a function of time difference between spike time tₚᵣₑ of the pre-synaptic neuron and spike time tₚₒₛₜ of the post-synaptic neuron (i.e., t =tₚₒₛₜ−tₚᵣₑ). A typical formulation of the STDP is to increase the synaptic weight (i.e., potentiate the synapse) if the time difference is positive (the pre-synaptic neuron fires before the post-synaptic neuron), and decrease the synaptic weight (i.e., depress the synapse) if the time difference is negative (the post-synaptic neuron fires before the pre-synaptic neuron).

In the STDP process, a change of the synaptic weight over time may be typically achieved using an exponential decay, as given by,

$$Δ w ( t ) = \{ \begin{matrix}{a}_{+} {e}^{- t / {k}_{+}} + μ , t > 0 \\ {a}_{-} {e}^{t / {k}_{-}} , t < 0\end{matrix} , \qquad ( 1 )$$

where k₊ and k₋ are time constants for positive and negative time difference, respectively, a₊ and a₋ are corresponding scaling magnitudes, and μ is an offset that may be applied to the positive time difference and/or the negative time difference.

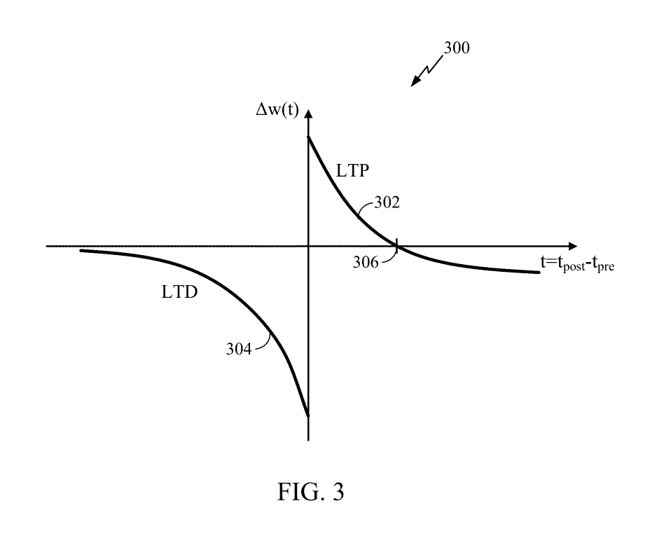

FIG. 3 illustrates an example graph diagram 300 of a synaptic weight change as a function of relative timing of pre-synaptic and post-synaptic spikes in accordance with the STDP. If a pre-synaptic neuron fires before a post-synaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between pre-synaptic and post-synaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a post-synaptic potential directly or in terms of the effect on neural state. If a second input spike (pulse) in the frame is considered correlated or relevant of a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ (t) governed by the following dynamics,

$$\frac{d {v}_{n} ( t )}{d t} = α {v}_{n} ( t ) + β {\sum }_{m} {w}_{m , n} {y}_{ m} ( t - Δ {t}_{m , n} ) , \qquad ( 2 )$$

where α and β are parameters, w_{m,n} is a synaptic weight for the synapse connecting a pre-synaptic neuron m to a post-synaptic neuron n, and yₘ(t) is the spiking output of the neuron m that may be delayed by dendritic or axonal delay according to Δt_{m,n} until arrival at the neuron n′s soma.

It should be noted that there is a delay from the time when sufficient input to a post-synaptic neuron is established until the time when the post-synaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.,

$$\begin{matrix}\frac{d v}{d t} = ( k ( v - {v}_{t} ) ( v - {v}_{r} ) - u + I ) / C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, l is a synaptic current, and C is a membrane's capacitance. In accordance with this model, the neuron is defined to spike when v >vₚₑₐₖ.

### Hunzinger Cold Model

The Hunzinger Cold neuron model is a minimal dual-regime spiking linear dynamical model that can reproduce a rich variety of neural behaviors. The model's one-or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

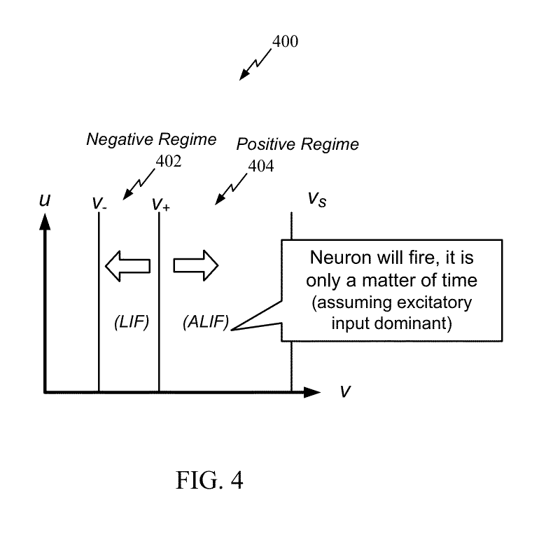

As illustrated in FIG. 4, the dynamics of the model may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as,

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q _{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₋ will generally be positive, as will be τᵤ.

The dynamics of the two state elements may be coupled at events by transformations offsetting the states from their null-clines, where the transformation variables are

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v is the base voltage for the negative regime, and the membrane potential will generally decay toward v₋ in the negative regime. The parameter v₊ is the base voltage for the positive regime, and the membrane potential will generally tend away from v in the positive regime.

The null-clines for v and u are given by the negative of the transformation variables q_{ρ} and r, respectively. The parameter δ is a scale factor controlling the slope of the u null-cline. The parameter ε is typically set equal to —v₋. The parameter β is a resistance value controlling the slope of the v null-clines in both regimes. The r_{ρ} time-constant parameters control not only the exponential decays, but also the null-cline slopes in each regime separately.

The model may be defined to spike when the voltage v reaches a value vₛ . Subsequently, the state may be reset at a reset event (which may be one and the same as the spike event):

v=\hat{v} (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ t ) = ( u ( t ) + r ) {e}^{- \frac{Δ t}{{τ}_{u}}} - r & ( 12 )\end{matrix}$$

Therefore, the model state may be updated only upon events such as upon an input (pre-synaptic spike) or output (post-synaptic spike). Operations may also be performed at any particular time (whether or not there is input or output).

Moreover, by the momentary coupling principle, the time of a post-synaptic spike may be anticipated so the time to reach a particular state may be determined in advance without iterative techniques or Numerical Methods (e.g., the Euler numerical method). Given a prior voltage state v0, the time delay until voltage state v_{f} is reached is given by

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches vₛ , then the closed-form solution for the amount of time, or relative delay, until a spike occurs as measured from the time that the voltage is at a given state v is

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., lms). This does not necessarily require iterative methods or numerical methods. An event-based implementation is also possible at a limited time resolution in a step-based simulator by only updating the model if an event occurs at or between steps or by “step-event” update.

### Value Synchronization Across Neural Processors

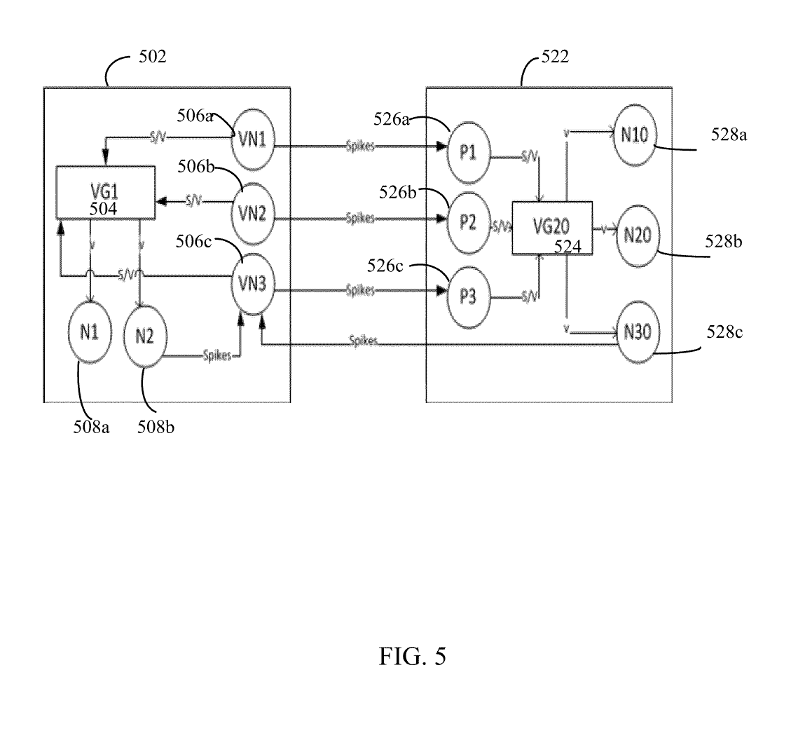

Aspects of the present disclosure are directed to synchronizing values in a neural network over a spike interface. FIG. 5 is a high level block diagram illustrating an exemplary system architecture for synchronizing values between neural processors in a neural network. The system architecture 500 comprises neural processors 502 and 522 that may be utilized alone or in combination to emulate a neural system. Further, the neural processors 502 and 522 may be included in the same processing chip or may be provided in separate processing chips. For ease of illustration and explanation, the system architecture 500 is shown as including two neural processors (502 and 522). However, this is merely exemplary, and additional neural processors or processing blocks may be included in the system architecture for processing in the neural network.

Neural processor 502 may comprise a value generator (VG) 504. The value generator 504 may be configured to generate values to be shared with neurons in the system for modeling neuron dynamics. In some aspects, the value may be a neuron parameter, a synaptic weight or delay value, or other value or attribute for use in emulating a neural system. For example, the value may correspond to a neuromodulator value such as a common dopamine value to be applied to neurons across the neural network. In a second example, the value may correspond to a neuromodulator value such as a common dopamine value to be applied to synapses across the neural network. In yet another example, the value may correspond to identification information for a neuron or neurons (e.g., 508) that have fired. In some aspects, the value may further include timing information, for example, to indicate a time (τ) at which a particular neuron fires or a timing at which a value is to be applied or consumed by a neuron. There may be one value generator 504, 524 for each processing block 502, 522 (as shown), or there may be multiple value generators 504, 524 for each processing block 502, 522. For example there can be one value generator 504, 524 for each neuron 508, 528, or even one value generator 504, 524 for each neuron type or neuron cluster within each processing block 502, 522.

The value generator 504 may be configured to perform a value calculation to generate values based, for example, on neural properties such as spikes or other attributes (e.g., synapse weight and/or delay). In some aspects, neurons 508 may send spikes to the value generator 504 to affect the value calculation. Additionally, neurons of remote processors (e.g., 522) in the neural system may also send spikes to the value generator 504 to affect the value calculation. Further, while FIG. 5 shows only one value generator in a processing block, this is merely exemplary and neural processor 502 (as well as neural processor 522) could be configured with additional value generators. For example, the neural processors 502, 522 could be configured with a value generator for each neuron or neuron type.

The neural processor 502 may also include value neurons (VNs) 506a, 506b, 506c (collectively value neurons 506). The value neurons 506 may be configured to generate spikes. The spikes are similar to a binary value. That is, they are either on or off In some aspects, the value neurons 506 generate spikes that correspond to values generated by the value generator 504. That is, the value neurons 506 may produce output spikes encoded with the value generated by the value generator 504 based on a spike protocol. For example, the value neurons 506 may encode the spikes using an inter-spike interval (ISI), binary encoding or other protocol for generating spikes.

In some aspects, one or more of value neurons 506 may be used to manage a value to be shared with other neurons in the neural network. For example, one or more of the value neurons 506 may monitor a value (e.g., common dopamine value) used by neurons 508. If adjustments are made to the value, the value neurons 506 may be used to update other neurons (e.g., 528) to utilize the value with respect to the change.

The neural processor 502 may further comprise one or more neurons 508a, 508b (which may be collectively referred to as neurons 508). The neurons 508 may receive spike inputs and consume values to model aspects of neuron behavior or dynamics in a neural network. In turn, the neurons 508 may output spikes to affect other neurons in the neural network. In some aspects, the neurons 508 may also send spikes to the value neurons 506 to adjust the value generator 504. For example, the neurons 508 may send spikes to the value neurons 506 to affect (e.g., delay) value generation. The spikes from the neurons 508 to the value neurons 506 can also synchronize values across processors. The neurons 508 shown in FIG. 5 may also represent neuron types, rather than individual neurons.

Neural processor 502 may be configured to transmit information to and receive information from remote neural processors (e.g., 522) in the neural network via an interface (not shown). In some configurations, the interface may comprise a network of synapses as illustrated in FIG. 1. In some aspects, the interface may be configured to transmit and receive spikes only. In such configurations, the scalar values generated by the value generator 504 cannot be directly transmitted to the remote neural processors (e.g., 522). However, because spikes may be transmitted via the interface, information regarding the values generated by the value generator 504 may be communicated to remote processors in the form of spikes produced by the value neurons 506. That is, the neural processor 502 may share a value generated by the value generator 504 with a remote neural processor (e.g., 522) by encoding the value into spikes using the value neurons 506 and transmitting the spikes to the remote neural processor 522.

To receive the transmitted spikes from the neural processor 502, neural processors 522 may comprise proxy neurons (P) 526a, 526b, 526c (collectively referred to as proxy neurons 526). The proxy neurons 526 may be configured to receive spikes from the value neurons (e.g., 506). The proxy neurons 526 may provide the spikes and/or other properties (e.g., neuron state) to a value generator 524. In doing so, the proxy neurons 526 may, in some aspects, drive the value generator 524 to generate a value on the remote neural processor 522 based on the received spikes.

The value generator 524, may in turn, perform a value calculation to generate a value based on the received spikes and/or other properties. In some aspects, the value generator 524 may be configured to perform a value calculation to generate a value such that the value is synchronized with a first value generated by value generator 504. Further, in some aspects, the value generator 524 may be configured to generate a value that is the same as that generated by the value generator 504.

One or more of neurons 528a, 528b, 528c (may be collectively referred to as neurons 528) may consume the value generated by value generator 524 to further model aspects of neuron behavior or dynamics in the neural network.

In some aspects, neural processor 522 may access a connectivity lookup table to determine routing of the value generated by the value generator 524. The connectivity lookup table may provide source and destination information for the generated values. That is, the connectivity lookup table may identify the neurons that are to consume a particular value.

In some aspects, a connectivity look up table may be used to determine routing for the values generated via the value generators (504, 524). The connectivity lookup table may include source and destination information and may be used to determine which neurons (508, 528) are to receive the value generated. For example, when the value generated by the value generator 524 identifies pre-synaptic neurons that have fired, the connectivity lookup table may be used to determine the neurons 528 to receive contribution from the pre-synaptic neurons that fired. In another example, when the value generated by the value generator 524 corresponds to a shared neuromodulator value (e.g., a common dopamine value), the connectivity table may indicate the neurons 528 to consume the generated value.

Additionally, in some cases, the neurons 508 and 528 may send spikes to the value neurons (506) to adjust a value generated by the value generator (504). In other cases, the neurons 508 and 528 may send spikes to proxy neurons 526 to adjust a value generated by the value generator 524.

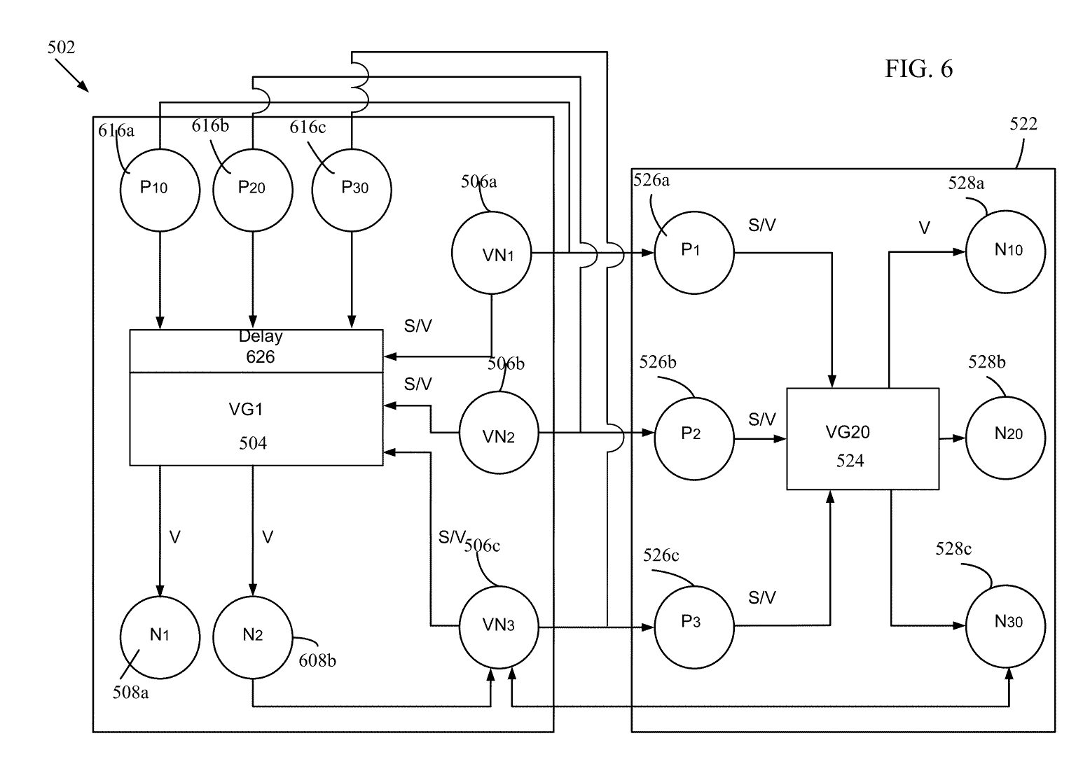

FIG. 6 is a high level block diagram illustrating an exemplary system architecture for synchronizing values between neural processors in a neural network. As shown in FIG. 6, neural processor 502 may be configured with additional proxy neurons 616a, 616b, 616c (collectively referred to as proxy neurons 616). The proxy neurons 616 may be defined between the value neurons (506) and the value generator (504) of the first neural processor 502. In some aspects, the proxy neurons 616 may be utilized to replicate a delay generated when transmitting the spikes from the first neural processor 502 to the second neural processor 522.

Further, the neural processor 502 may be configured with a delay generator 626. As illustrated in FIG. 6, the delay generator 626 may be defined within the neural processor 502. However, this is merely exemplary, and the delay generator 626 may be included in other components of the neural processor 502 or may be provided as a separate component. In some aspects, the delay generator 626 may be used to replicate the delay generated when transmitting the spikes from the neural processor 502 to the second neural processor 522. The delay could approximate the delay between the processors 502, 522 or could include some padding so the approximated delay is longer than the actual delay. In some configurations, neural processor 522 may also be configured with a delay generator to replicate the delay generated when transmitting the spikes from the neural processor 522 to the neural processor 502.

Furthermore, in some configurations, the value neurons 506 of first neural processor 502 may transmit a specific sequence of spikes to reset the second neural processor 522.

Neurons on the remote neural processor 522 may access the value provided from the first neural processor 502. Thus, the value generated in the neural processor 502 may be deemed synchronized with the value generated in the remote neural processor 522.

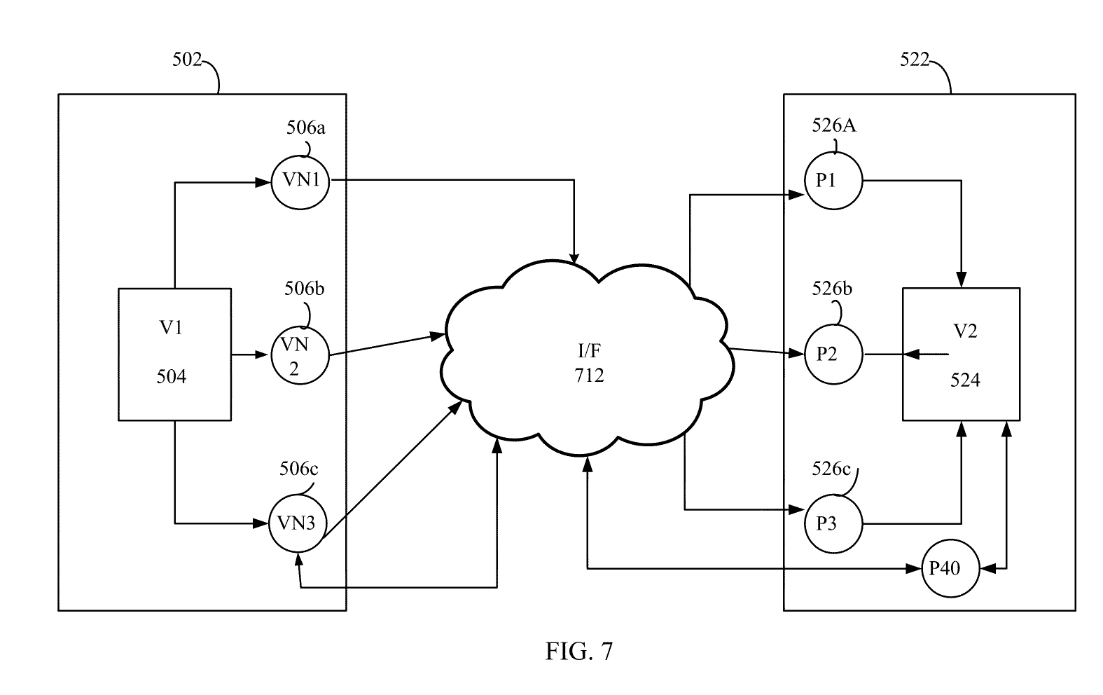

FIG. 7 is a high level block diagram illustrating an exemplary system for encoding and decoding spikes. As discussed above, value neurons 506 may be used to monitor or manage a value V1 that is to be shared with neurons across the neural network. In some aspects, the value V1 may provide an indication of the neurons that spiked at a particular time. The value V1 may also be a value that is to be shared by neurons across the neural network such as a neuromodulator value (e.g., common dopamine value).

In the example of FIG. 7, the value neurons 506 are used to manage the value V1. When the value V1 is to be shared with a neuron across the neural network, the value neurons 506 may be used to convert the value V1 to spikes for transmission across the inter-block interface 712. In some aspects, the inter-block interface 712 may be configured such that only spikes may be communicated via the interface, and can be, for example, a network of synapses. Further, the inter-block interface 712 may be configured to operate as a spike channel between neural processors.

In some aspects, the value may be divided into one or more component parts. For example, the value V1 may be divided into its most significant bits and least significant bits. In another example, the value V1 may be divided into a predefined number of portions (e.g., ½of the bits, ⅓of the bits, etc.)

The value neurons 506 may generate spikes encoded with the value V1 based on a spike protocol. The spike protocol may employ an encoding scheme such as, for example, absolute latency coding, relative latency coding, rate coding, and the like.

In absolute latency coding, the value may be encoded based on the time between spike events for a particular neuron or set of neurons. For example, to encode a value of 8, an 8 ms delay may be included between spike events for the neuron. In some aspects, the value may also be scaled to generate the encoded value. Further, in some aspects the encoded value may be a function of the absolute latency value.

In relative latency coding, the value may be encoded according to the interval between spikes for a plurality of neurons. For example, where a neuron N₁ spikes at a time t₁ and neuron N₂ spikes at a time t₂, the value may be represented as the time difference t₂−t₁.

In rate coding, the value may be represented according to a number of spikes that occur within a particular interval. For example, spikes may be sampled for a 10 ms interval with the encoded value corresponding to the number of spikes that occurred during the 10 ms period. In some aspects, the value may be encoded based on a spike rate for one neuron or a spike rate for multiple neurons.

The encoding schemes described above are merely exemplary and in some aspects, the spike protocol may employ Inter-Spike Interval (ISI) coding, binary coding, or other encoding schemes for generating spikes encoded with the value V1.

Connectivity information indicating a particular neuron or neurons that spiked may also be included in the spikes transmitted via value neurons. The connectivity information may be used to route the values encoded and transmitted as spikes to neurons in a remote neural processor (e.g., 522). In some aspects, the connectivity information may include an index identifying one or more neurons that spiked (i.e., source neuron(s)). The connectivity information may further include destination information identifying one or more neurons that are to receive contributions based on the neuron that spiked.

The proxy neurons 526 receive the spikes sent from the processing block 502. In some aspects, spikes may be received by additional receiver neurons to provide redundancy to recover from spike transmission issues (e.g. spike loss). For example, in some aspects a spike train transmitted via value neuron 506a may be received via multiple proxy neurons (e.g., (526a, 526b, and/or 526c). In a further example, a spike train received via proxy neurons 526 and neurons 528 of neural processor 522.

The proxy neurons 526 then provide the spikes, which correspond to the first value or a component thereof, to the value generator 524 which decodes the spikes and generates a second value V2. In some aspects, the value generator 524 may be configured to decode spikes encoded based on the spike protocol employed by value neurons 506. Because the spikes may be encoded with timing information, the second value V2 may be generated such that the second value V2 is synchronized with the first value V1. In some aspects, the second value V2 is the same as or equal to the first value V1.

In some aspects, a connectivity look up table may be used to determine routing for the generated values. The connectivity lookup table may include source and destination information and may be used to determine which neurons of the neural processor 522 are to receive the value generated by the value generator 524. For example, when the value generated by the value generator 524 identifies pre-synaptic neurons that have fired, the connectivity lookup table may be used to determine the neurons 528 (FIGS. 5 and 6) which are to receive contribution from the pre-synaptic neurons that fired. In another example, when the value generated by the value generator 524 corresponds to a shared neuromodulator value (e.g., a common dopamine value), the connectivity table may indicate the neurons 528 which are to consume the generated value.

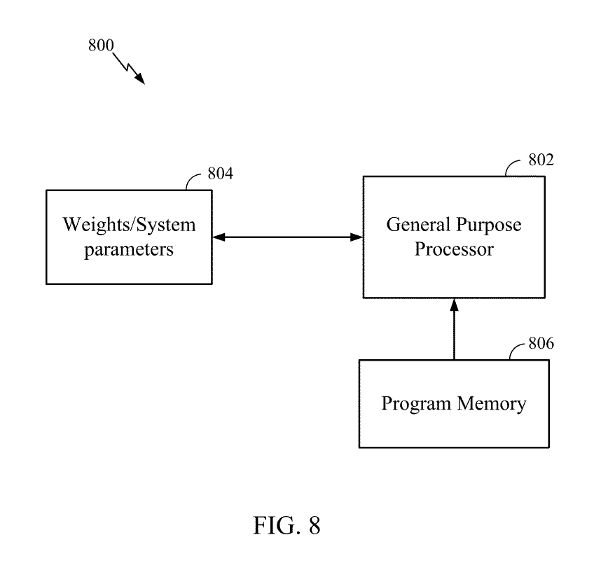

FIG. 8 illustrates an example implementation 800 of the aforementioned method for synchronizing values across processing blocks (e.g., neural processors 502, 522) in a neural network using a general-purpose processor 802 in accordance with certain aspects of the present disclosure. Variables (neural signals), synaptic weights, and system parameters associated with a computational network (neural network) may be stored in a memory block 804, while instructions executed at the general-purpose processor 802 may be loaded from a program memory 806. In an aspect of the present disclosure, the instructions loaded into the general-purpose processor 802 may comprise code for synchronizing values across processing blocks in a neural network. For example in some configurations, the general-purpose processor 802 may comprise code for generating spikes in a first processing block corresponding to a first value. Further, in the exemplary configuration, the general-purpose processor 802 may further comprise code for transmitting spikes across an inter-block interface from the first processing block to a second processing block in such a way that a second value generated by the value generator in the second processing block will be synchronized with the first value.

In another exemplary configuration, the general-purpose processor 802 may comprise code for receiving spikes corresponding to a first value from a first processing block via an interblock interface. Further, in this exemplary configuration, the general-purpose processor 802 may further comprise code for decoding the spikes in a second processing block and generating a second value, the second value being synchronized with the first value.

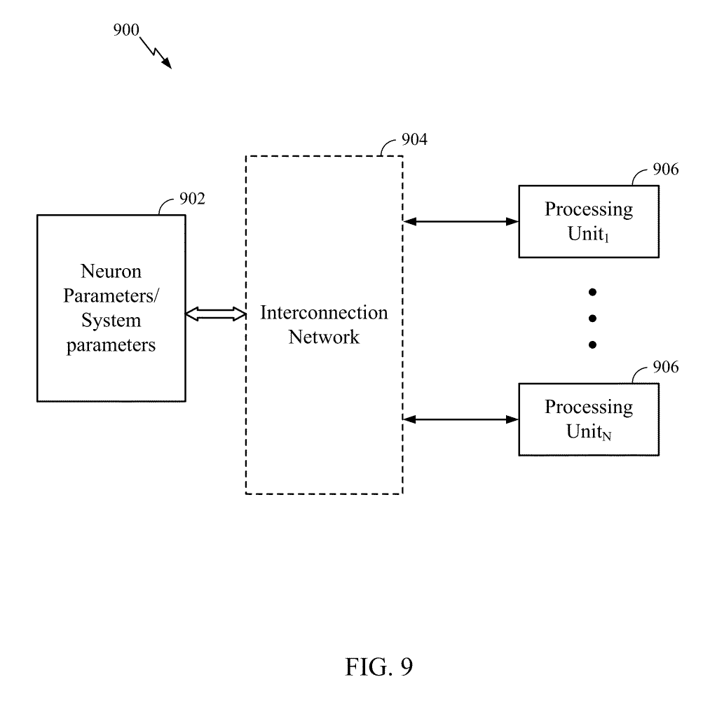

FIG. 9 illustrates an example implementation 900 of the aforementioned method for synchronizing values across processing blocks of the neural network where a memory 902 can be interfaced via an interconnection network 904 with individual (distributed) processing units (neural processors) 9061 . . . 906N of a computational network (neural network) in accordance with certain aspects of the present disclosure. Variables (neural signals), synaptic weights, and system parameters associated with the computational network (neural network) may be stored in the memory 902, and may be loaded from the memory 902 via connection(s) of the interconnection network 904 into each processing unit (neural processor) 906. In some aspects, values generated via the processing blocks as well as a connectivity information may also be stored in memory 902 and loaded therefrom for further processing. In an aspect of the present disclosure, the processing unit 906 may be configured to synchronize values across processing blocks of the neural network. For example, in some configurations, the processing unit 906 may be configured to generate spikes in a first processing block corresponding to a first value. In addition, the processing unit 906 of the exemplary configuration may be further configured to transmit spikes across an inter-block interface from the first processing block to a second processing block in such a way that a second value generated by a value generator in the second processing block will be synchronized with the first value.

In another exemplary configuration, the processing unit 906 may be configured to receive spikes corresponding to a first value from a first processing block via an interblock interface. Further, in this exemplary configuration, the processing unit 906 may be further configured to decode the spikes in a second processing block and generate a second value, the second value being synchronized with the first value.

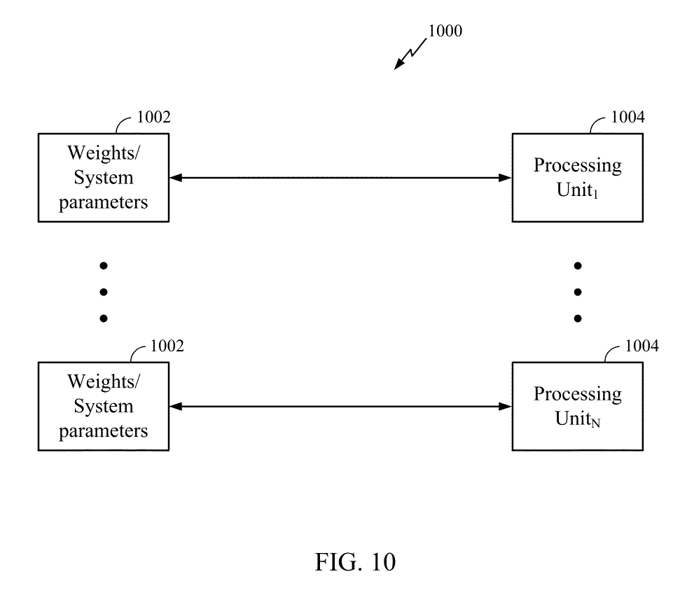

FIG. 10 illustrates an example implementation 1000 of the aforementioned method for synchronizing values across processing blocks of the neural network. As illustrated in FIG. 10, one memory bank 1002 may be directly interfaced with one processing unit 1004 of a computational network (neural network). Each memory bank 1002 may store variables (neural signals), synaptic weights, and system parameters associated with a corresponding processing unit (neural processor) 1004. In some aspects, values generated via the processing blocks may also be stored in memory 1002 and loaded therefrom for further processing. Further, in some aspects connectivity information may be stored in memory 1002. In an aspect of the present disclosure, the processing unit 1004 may be configured to synchronize values across processing blocks of the neural network synchronizing values across processing blocks of the neural network.

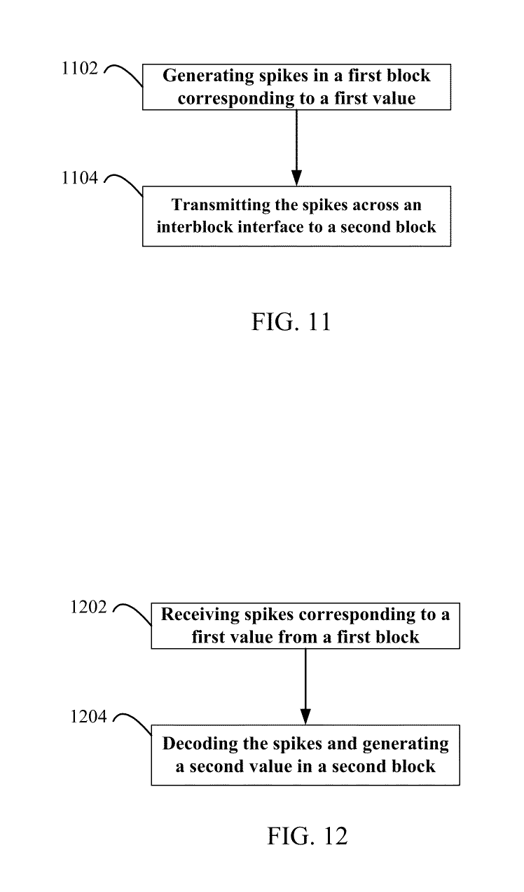

FIG. 11 illustrates a method for synchronizing values across neural processor blocks in a neural network. In block 1102, the neuron model generates spikes in a first processing block corresponding to a first value. Furthermore, in block 1104, the neuron model transmits the spikes across an interblock interface to a second processing block value generator in a second processing block in such a way that a second value generated by a value generator in the second processing block will be synchronized with the first value.

FIG. 12 illustrates a method for synchronizing values across neural processor blocks in a neural network. In block 1202, the neuron model receives spikes corresponding to a first value from a first processing block in a second processing block via an interblock interface. Furthermore, in block 1204, the neuron model decodes the spikes in the second processing block and generates a second value. The second value is synchronized with the first value.

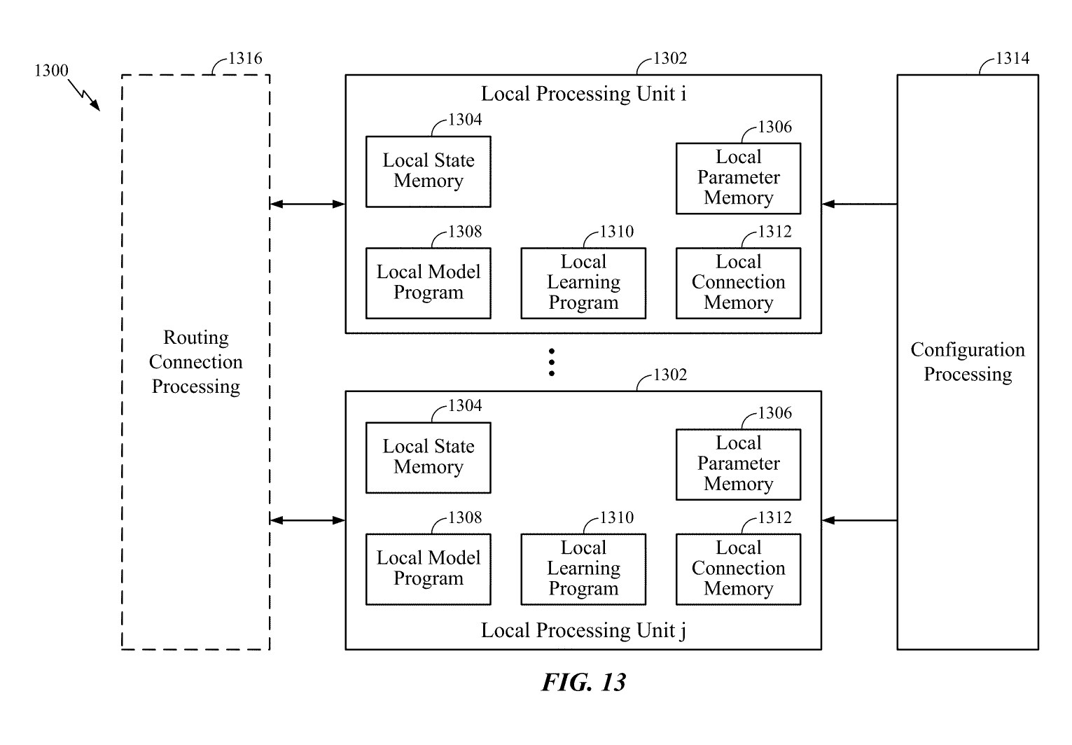

FIG. 13 illustrates an example implementation of a neural network 1300 in accordance with certain aspects of the present disclosure. As illustrated in FIG. 13, the neural network 1300 may have multiple local processing units 1302 that may perform various operations, as described above. Each processing unit 1302 may comprise a local state memory 1304 and a local parameter memory 1306 that store parameters of the neural network. In addition, the processing unit 1302 may have a memory 1308 with local (neuron) model program, a memory 1310 with local learning program, and a local connection memory 1312. Furthermore, as illustrated in FIG. 13, each local processing unit 1302 may be interfaced with a unit 1314 for configuration processing that may provide configuration for local memories of the local processing unit, and with routing connection processing elements 1316 that provide routing between the local processing units 1302.

In one configuration, a neuron model is configured for synchronizing values across neural processor blocks in a neural network. The neuron model includes a generating means and a transmitting means. In one aspect, the generating means and/or transmitting means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

In one configuration, a neuron model is configured for synchronizing values across neural processor blocks in a neural network. The neuron model includes a receiving means and a decoding means. In one aspect, the receiving means and/or decoding means may be the general-purpose processor 502, program memory 506, memory block 504, memory 602, interconnection network 604, processing units 606, processing unit 704, local processing units 802, and or the routing connection processing elements 816 configured to perform the functions recited. In another configuration, the aforementioned means may be any module or any apparatus configured to perform the functions recited by the aforementioned means.

According to certain aspects of the present disclosure, each local processing unit 1302 may be configured to determine parameters of the neural network based upon desired one or more functional features of the neural network, and develop the one or more functional features towards the desired functional features as the determined parameters are further adapted, tuned and updated.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in Figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for synchronizing values across processing blocks, comprising:
generating spikes corresponding to a first value in a first processing block; and
transmitting the spikes across an inter-block interface from the first processing block to a second processing block, the spikes being encoded with the first value such that a second value generated in the second processing block based on the spikes will be synchronized with the first value.

2. The method of claim 1, in which the second value is a same value as the first value.

3. The method of claim 1, further comprising:
affecting neurons and/or synapses in the first processing block based at least in part on the first value; and
affecting neurons and/or synapses in the second processing block based at least in part on the second value.

4. The method of claim 1, further comprising generating the first value in the first processing block via a value generator and delaying processing within the value generator of the first processing block.

5. The method of claim 4, in which the delaying accounts for a delay between transmitting to the second processing block and generation of the second value.

6. The method of claim 1, further comprising:
transmitting spikes from value neurons in the first processing block to a plurality of proxy neurons in the first processing block; and
communicating spikes and/or neuron state from the plurality of proxy neurons in the first processing block to a value generator in the first processing block.

7. The method of claim 1, further comprising generating a predefined spike pattern from at least one value neuron to cause a proxy neuron in the second processing block to reset.

8. A method for synchronizing values across processing blocks, comprising:
receiving spikes corresponding to a first value from a first processing block; and
decoding the spikes in a second processing block to generate a second value, the second value being synchronized with the first value.

9. A first processing block for synchronizing values with a second processing block, the first processing block comprising:
at least one value generator;
a plurality of value neurons configured to generate spikes corresponding to a first value, and to transmit the spikes to the at least one value generator and also across an inter-block interface to proxy neurons within a second processing block, the spikes being encoded with the first value such that a second value generated in the second processing block based on the spikes will be synchronized with the first value; and
at least one neuron configured to receive the first value from the at least one value generator.

10. The first processing block of claim 9, in which the at least one value generator comprises a single value generator.

11. The first processing block of claim 9, in which the at least one value generator comprises a plurality of value generators and in which at least one value generator of the plurality of value generators is provided for each neuron.

12. The first processing block of claim 9, in which the at least one value generator comprises a plurality of value generators, and in which at least one value generator of the plurality of value generators is provided for each neuron type in the first processing block.

13. A local processing block for synchronizing values with a remote processing block, the local processing block comprising:
at least one proxy neuron configured to receive spikes corresponding to a first value from the remote processing block;
at least one value generator configured to decode the spikes and to generate a second value that is synchronized with the first value; and
at least one neuron configured to receive the second value from the at least one value generator.

14. An apparatus for synchronizing values across processing blocks, the apparatus comprising:
a memory; and
at least one processor coupled to the memory, the at least one processor being configured:
to generate spikes corresponding to a first value in a first processing block; and
to transmit the spikes across an inter-block interface from the first processing block to a second processing block, the spikes being encoded with the first value such that a second value generated in the second processing block based on the spikes will be synchronized with the first value.

15. The apparatus of claim 14, in which the second value is a same value as the first value.

16. The apparatus of claim 14, in which the at least one processor is further configured:
to affect neurons and/or synapses in the first processing block based at least in part on the first value; and
to affect neurons and/or synapses in the second processing block based at least in part on the second value.

17. The apparatus of claim 14, in which the at least one processor is further configured to generate the first value in the first processing block via a value generator and to delay processing within the value generator of the first processing block.

18. The apparatus of claim 17, in which the delayed processing accounts for a delay between transmitting to the second processing block and generation of the second value.

19. The apparatus of claim 14, in which the at least one processor is further configured:
to transmit spikes from value neurons in the first processing block to a plurality of proxy neurons in the first processing block; and
to communicate the spikes and/or neuron state from the plurality of proxy neurons in the first processing block to a value generator in the first processing block.

20. The apparatus of claim 14, in which the at least one processor is further configured to generate a predefined spike pattern from at least one value neuron to cause a proxy neuron in the second processing block to reset.

21. An apparatus for synchronizing values across processing blocks, comprising:
a memory; and
at least one processor coupled to the memory, the at least one processor being configured:
to receive spikes corresponding to a first value from a first processing block; and
to decode the spikes in a second processing block to generate a second value, the second value being synchronized with the first value.

22. An apparatus for synchronizing values across processing blocks, comprising:
means for generating spikes corresponding to a first value in a first processing block; and
means for transmitting the spikes across an inter-block interface from the first processing block to a second processing block, the spikes being encoded with the first value such that a second value generated in the second processing block based on the spikes will be synchronized with the first value.

23. An apparatus for synchronizing values across processing blocks, comprising:
means for receiving spikes corresponding to a first value from a first processing block; and
means for decoding the spikes in a second processing block to generate a second value, the second value being synchronized with the first value.

24. A computer program product for synchronizing values across processing blocks, comprising:
a non-transitory computer readable medium having encoded thereon program code, the program code comprising:
program code to generate spikes corresponding to a first value in a first processing block; and
program code to transmit the spikes across an inter-block interface from the first processing block to a second processing block, the spikes being encoded with the first value such that a second value generated in the second processing block based on the spikes will be synchronized with the first value.

25. A computer program product for synchronizing values across processing blocks, comprising:
a non-transitory computer readable medium having encoded thereon program code, the program code comprising:
program code to receive spikes corresponding to a first value from a first processing block; and
program code to decode the spikes in a second processing block to generate a second value, the second value being synchronized with the first value.
